(19) United States
(12) Patent Application Publication
(10) Pub. No.: US 2004/0071320 A1
(43) Pub. Date: Apr. 15, 2004

(54) In vivo small animal image analysis process and apparatus for image evaluation for in vivo small animal imaging

(76) Inventor: Marcus Pfister, Erlangen (DE)

Correspondence Address: HARNESS, DICKEY & PIERCE, P.L.C., P.O.BOX 8910, RESTON, VA, 20195, US

(21) Appl. No.: 10/612,167

(22) Filed: Jul. 3, 2003

(30) Foreign Application Priority Data
Jul. 3, 2002 (DE) 10229880.7

(51) Int. Cl. G06K 9/00

(52) U.S. Cl. 382/110

(57) ABSTRACT

An image analysis process is for in vivo small animal imaging, and an apparatus is for image evaluation for the in vivo small animal imaging, for automatic evaluation of two-dimensional and/or three-dimensional images. One-dimensional, two-dimensional or three-dimensional image data are read and the image data are segmented on the basis of image data characteristics, into segments. The image data characteristics represent areas of interest for the small animal. Cohesive areas are formed, carried out by association of the segments on the basis of association criteria. After the filtering of the cohesive areas and analysis on the basis of analysis criteria, changes in the areas of interest for the small animal can be detected automatically and quickly on the basis of an experimental databank, without any manual action or medical estimation being necessary.

The present application hereby claims priority under 35 U.S.C. §119 on German patent application number DE 10229880.7 filed Jul. 3, 2002, the entire contents of which are hereby incorporated herein by reference.

### FIELD OF THE INVENTION

The present invention generally relates to an in vivo small animal image analysis process for in vivo small animal imaging for automatic image evaluation, and/or to an apparatus for automatic in vivo small animal image evaluation for the image analysis process.

### BACKGROUND OF THE INVENTION

Small animal imaging is an important process in biological, medical and pharmaceutical research and is being increasingly used by the pharmaceutical industry for discovering and developing medicaments and active substances. In this case, on the one hand, new imaging processes are increasingly being used (for example light in the NIR band), as well as classical technologies such as magnetic resonance (MR), computed tomography (CT) or else nuclear medical processes (PET or SPECT). Particularly in the case of nuclear medical processes and in the case of optical (fluorescence) imaging, specific substances, so-called metabolic markers, are administered here which either build up exclusively in specific regions of the small animal, such as in tumors, inflamed areas or other specific sources of debilitation, or which, although they are distributed throughout the body of the small animal, are activated only specifically in certain areas, for example by way of tumor-specific enzyme activities (and, for example, by additional illumination by light).

The observation of the development and of the changes over time to these centers marked in this way, for example with the addition of a medicament that is on trial, allows conclusions to be drawn about the effectiveness and efficiency of the medicament.

A number of imaging devices are already known for in vivo small animal imaging for evaluation of two-dimensional and/or three-dimensional images. Examples include Micro-PET from Concorde Microsystems Inc., Micro-SPECT from Gamma Medica Inc., Micro-CT from ImTec Inc. or Micro-MR from Bruker (www.cms-asic.com; www.gammamedica.com; www.imtecinc.com; www.bruker-medical.de). Only one commercial device is so far known in the field of optical imaging (www.xenogen.com).

The known systems and processes display the image information in such a way that certain manual manipulations such as rotations, zoom and contrast changes are possible. Most computer-aided user platforms thus allow access to image data, which is manually evaluated, measured and stored.

By way of example, WO 01/37195 discloses a computer-aided process for identification and measurement of what are referred to as ROIs (Regions of Interest; areas of interest) for the small animal, the storage of the results in an experimental databank, and their comparison once the process has been carried out once again.

DE 198 45 883 discloses a process for carrying out biotests, in which biological samples which are arranged in sample cases are recorded optically and are examined by image analysis. In order to determine the growth of samples, biotests are carried out at time intervals.

DE 42 11 904 discloses a process for carrying out tests on liquid biological samples in order to create a type list of the types which can be verified in the sample. In this case, the samples are recorded optically, and are examined by image analysis. The types in the sample can be verified on the basis of the external specific shape.

DE 38 36 716 discloses a processes with an apparatus for in vitro examination of cell cultures with tumors, with the cell samples being recorded optically and being examined by image analysis. However, this process is semi-automatic, that is to say the user has to mark cell image sequences in order to allow the evaluation to be carried out by the image analysis device.

These known systems and processes have the disadvantage that they involve complex manual identification of areas of interest for the small animal and detection of individual tumors, inflamed areas or other debilitation sources, even though it is of extremely major importance to pharmaceutical companies to carry out appropriate experiments and trials series extremely quickly. Even after the trials results have been stored, they must be manually compared with results from previous examinations in order, for example, to determine the effectiveness of a medicament. Owing to the large number of small animal trials, rapid evaluation of the trials results for a high trials throughput rate is feasible only with high personnel costs, and with increased manual effort.

### SUMMARY OF THE INVENTION

An embodiment of the invention is thus based on an object of specifying an image analysis process and an apparatus for evaluation of images for in vivo small animal imaging, which makes it possible to considerably speed up trials and trials series for medicament developments and potential introduction, and allows automated and possibly computer-aided examination evaluation.

The image analysis process according to an embodiment of the invention for in vivo small animal imaging for automatic evaluation of two-dimensional and/or three-dimensional images which comprise one-dimensional, two-dimensional or three-dimensional image data comprises, inter alia, the following process steps:

a) preparation of the small animal,

b) recording of two-dimensional and/or three-dimensional images (1) of the small animal by way of an imaging examination device,

c) reading of the two-dimensional and/or three-dimensional image data (3) for the small animal,

d) segmentation of the image data (3) on the basis of image data characteristics, which can be predetermined, into segments (2), with the image data characteristics, which can be predetermined, representing areas of interest for the small animal,

e) formation of cohesive areas (4) by way of association of the segments (2) on the basis of association criteria which can be predetermined, in that the cohesive areas (4) are filtered by masking out the remaining image data (5) which is not associated with the cohesive areas (4),

f) if appropriate, filtering of the cohesive areas (4) and analysis of the cohesive areas (4) on the basis of analysis criteria which can be predetermined,

g) storage of the analyzed area data and/or segment data in a data memory, and

h) repeated carrying out of steps a) to g) for the same small animal at time intervals.

Before the two-dimensional and/or three-dimensional images are read, the small animal is recorded by way of a conventional imaging examination process.

The analyzed area data and/or segment data is stored in a databank in accordance with step g), and the image analysis process is carried out two or more times for the same small animal, at time intervals. Thus, the small animal is examined two or more times, with time intervals in between them, by way of the same analysis process. The area data is in this case the image data for the cohesive areas which have previously been filtered out. The segment data is that image data which has been segmented on the basis of the previously mentioned image data characteristics which can be predetermined. Both the area data and the segment data are stored for image analysis processes, which are carried out automatically and successively, in the databank, so that an experimental databank is produced successively. The cohesive areas are advantageously filtered by masking out the remaining image data which is not associated with the cohesive areas.

In order to form this experimental databank, the following further steps are advantageously carried out after the storage of the analyzed area data and/or segment data:

i) quantification of the analyzed area data and/or segment data,

j) comparison of the quantified area data and/or segment data with stored area data and/or segment data from previous examinations,

k) measurement and/or detection of a change in the segments and/or in the cohesive areas, and

l) storage of the results in the databank.

This makes it possible to measure, and to once again store, a change in the segments or in the cohesive areas on the basis of the stored area data and/or segment data by way of a comparison of the analyzed area data and/or segment data with stored area data and/or segment data from previous analysis processes. The automatically measured changes in the segments or in the cohesive areas allow a dynamic sequence observation of a tumor, or of some other debilitation, which has been treated, for example, by way of pharmaceutical preparations to be stored and to be displayed later. The measured changes in the segments, the changes in the cohesive areas, the dynamic sequence observation, the analysis criteria and their results as well as other parameters relating to the process according to an embodiment of the invention are advantageously displayed graphically on the basis of workflows. A workflow for the purposes of this invention refers to automated identification, analysis, storage and display of image data, which is processed by way of the predetermined flowchart or analysis algorithm already described.

Process steps a) to h), and possibly process steps i) to l) as well, are carried out and displayed semi-automatically or automatically, on the basis of a predetermined workflow. If necessary, the user can monitor analysis results, and can advantageously modify them manually.

The apparatus according to an embodiment of the invention for image evaluation for in vivo small animal imaging for an image analysis process according to an embodiment of the invention has a device for reading, storage and evaluation of two-dimensional and/or three-dimensional images which include one-dimensional, two-dimensional or three-dimensional image data; a device for segmentation of the image data on the basis of image data characteristics, which can be predetermined, into segments, with the image data characteristics which can be predetermined representing areas of interest for the small animal; a device for forming cohesive areas by way of association of the segments on the basis of association criteria which can be predetermined; a device for filtering the cohesive areas; and a device for analysis of the cohesive areas on the basis of analysis criteria, which can be predetermined, and for automatic storage in a databank, which is advantageously an experimental databank.

Further, a device for storing and calling data in or from an experimental databank may likewise be provided, particularly when the measurement results of possible changes to the segments or to the cohesive areas have already been stored, in order in this way to produce an experimental databank. This allows long-term comparison of the measured analysis data.

The apparatus according to an embodiment of the invention advantageously has further a device for graphical comparison and indication of the measured changes in the segments and/or the cohesive areas, to the dynamic sequence observation, the analysis criteria and their results, as well as in the data from the experimental databank, in which case these devices should also advantageously allow the available data to be displayed on the basis of workflows. This may be achieved, for example, by using a window display on a personal computer.

### BRIEF DESCRIPTION OF THE DRAWINGS

An abstract example of the present invention will be explained in more detail with reference to the drawings, in which:

FIG. 1 shows a schematic two-dimensional view of image data which has already been segmented;

FIG. 2 shows a schematic view of cohesive and filtered areas of a two-dimensional image as shown in FIG. 1; and

FIG. 3 shows a schematic flowchart for the process according to an embodiment of the invention.

### DETAILED DESCRIPTION OF THE PREFERRED EMBODIMENTS

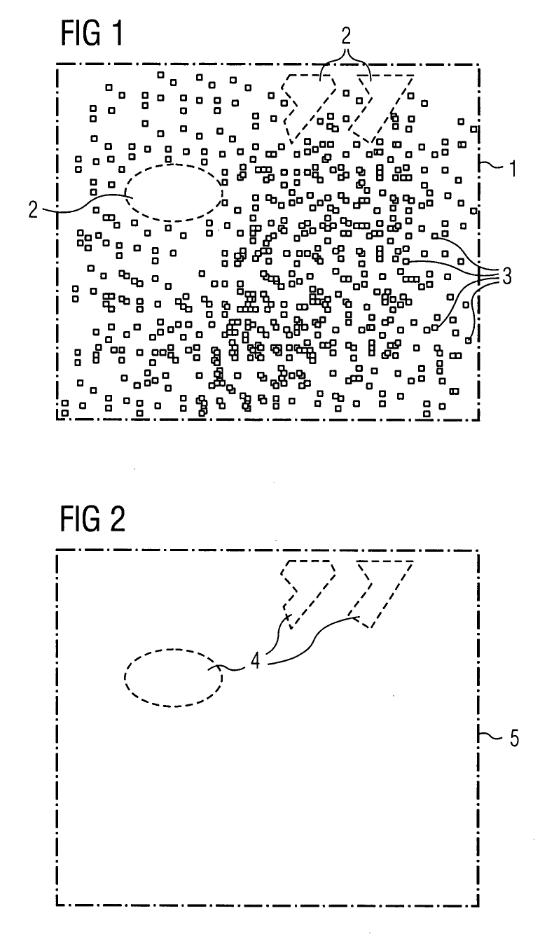

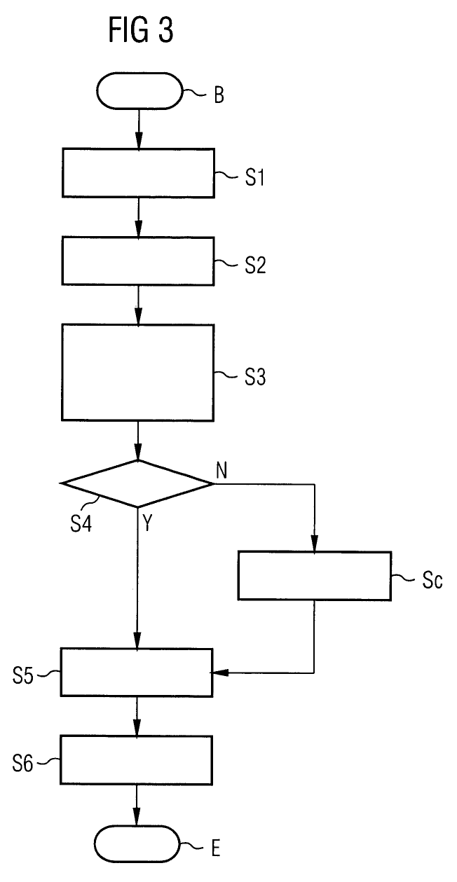

The image analysis process according to an embodiment of the invention is carried out on the basis of one preferred embodiment of the present invention in the following steps, which will be explained with reference to the flowchart in FIG. 3 and to the image data which is illustrated schematically in FIGS. 1 and 2.

The image analysis process is started (start B). The small animal is for this purpose prepared in a first step S1. That is, it is prepared for the examination, is immobilized, identified and is examined using one of the already mentioned examination processes.

In a second step S2, the image data for the examination process is read.

The third step S3 starts using a two-dimensional image 1, as illustrated by way of example in FIG. 1, in which specific characteristics are displayed by way of different gray-scale pixels. In the case of a three-dimensional image, these are corresponding voxels. These images 1 are produced by standard reconstruction processes for optical or nuclear medical imaging. In this case, the gray-scale values in the two-dimensional image 1 as illustrated by way of example in FIG. 1 represent concentrations (oxygen, contrast agent or the like), emission intensities or fluorescence lives of fluorophores, tissue densities, as well as emission, scatter or attenuation characteristics of the sample that is to be examined. The image data 3 illustrated in FIG. 1 corresponds, for example, to light intensities represented as gray-scale values.

However, it is also possible to represent various complex characteristics, provided that the image data 3 has been preprocessed in advance. These complex characteristics may be positional frequencies or three-dimensional structures of the tissue of the small animal, which can be represented by corresponding gray-scale value representations.

The image data 3 is segmented on the basis of image data characteristics, which can be predetermined, into segments 2. The areas to be recorded using a predetermined image data characteristic are separated from the background by data evaluation. Various methods exist for this purpose, such as the watershed algorithm (Patrick De Smet, Rui Pires—Implementation and analysis of an optimized rainfalling watershed algorithm—, Proceedings of the IS&T/SPIE's 12th Annual Symposium Electronic Imaging 2000: Image and Video Communications and Processing, January 2000), Region-Growing oder Segmentierung durch Binarisierung (Peter Haberäcker—Praxis der Digitalen Bildverarbeitung und Mustererkennung [Practice of Digital Image Processing and Pattern Recognition]—, Hanser 1995; Bernd Jähne—Digital Image Processing—, Springer Verlag Berlin, 1991), the entire contents of each of which are hereby incorporated herein by reference.

In optical fluorescence imaging, the wavelength of the light produced by the dye, or in nuclear medicine the expected energy from the quanta produced by the isotope, is known, so that the areas of interest for the small animal are distinguished as homogeneous spots (generally brighter spots) with specific gray-scale values. The segments 2 that are shown in FIG. 1 thus differ from the other black dotted areas of the two-dimensional image 1. Since all that is generally relevant is to provide the separation between the foreground and background, simple segmentation by conversion to binary form can be used for the problem provided that, as is shown in FIG. 1, these are two-dimensional gray-scale images 1.

Cohesive areas 4 are imaged by association of the segments 2 on the basis of association criteria which can be predetermined. One standard process for efficient processing of binary images and for their combination is run length encoding (Peter Haberäcker—Praxis der Digitalen Bildverarbeitung und Mustererkennung [Practice of Digital Image Processing and Pattern Recognition]—, Hanser 1995; Bernd Jähne—Digital Image Processing—, Springer Verlag Berlin, 1991), the entire contents of each of which are hereby incorporated herein by reference. It is also possible to post-process the cohesive areas 4 subsequently, that is to say to smooth them, to separate them or to combine them subsequently, in order to take account of specific geometric considerations (for example the fact that tumors generally have a spherical shape). This also makes it possible to reduce imaging disturbances that occur with traditional imaging processes.

Finally, the cohesive areas 4 are filtered by delineating the areas of interest from the “rest of the image”. As is shown in FIG. 2, the cohesive areas 4 are delineated from the remaining image data 5 by filtering (for example by way of a gray-scale value threshold which can be predetermined). The cohesive areas 4 can now be analyzed by centroid determination, determination of the size and/or mass, or by determination of substance concentration, that is to say all the characteristics which are coded indirectly or directly in the image by way of a pixel position (or voxel position) and pixel color can be calculated and evaluated. Especially in the case of fluorophores, model calculations based on known characteristics of the dyes and of the tissue can be used to deduce their concentrations in the tumor.

The analyzed data is advantageously stored on the basis of the predetermined analysis criteria mentioned above and, if required, is compared with data from previous measurements. The results can then be displayed dynamically.

In a fourth step S4, the results can then once again be checked for plausibility using further criteria. Further, in a fifth step S5, they can be stored with explanatory notes. If incorrect results are detected in the fourth step S4, these can be corrected in a correction step Sc, and, once this has been done, they can then be stored in the fifth step S5.

In a sixth step S6, the databank is updated with the results, and the small animal can be removed once again. This ends the process (end E).

The image analysis process is advantageously carried out two or more times for the same small animal, at time intervals. This results in a dynamic sequence observation by the image analysis process according to an embodiment of the present invention. In this case, the rapid and automatic extraction and measurement of the areas of interest makes it possible to determine changes in these areas reliably and quickly within a short time period. A workflow, that is to say an automatic procedure, guides the user through the process.

The graphical display of the measurement results can advantageously be provided by way of a window technique on the computer screen. Experiments can thus be evaluated and displayed more quickly. Long-term changes such as the growth of a tumor can thus be determined quickly and reliably by automatic evaluation and access to the experimental data from the experimental databank.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An in vivo small animal image analysis process for automatic evaluation of at least one of two-dimensional and three-dimensional images of small animals, the images including at least one of one-dimensional, two-dimensional and three-dimensional image data, the process comprising:
a) preparing the small animal;
b) recording at least one of two-dimensional and three-dimensional images of the small animal via an imaging examination device;
c) reading the at least one of two-dimensional and three-dimensional image data for the small animal;
d) segmenting the image data, based upon image data characteristics, into segments, wherein the image data characteristics represent areas of interest for the small animal;
e) formatting cohesive areas by associating the segments on the basis of association criteria, wherein the cohesive areas are filtered by masking out remaining image data not associated with the cohesive areas;
f) filtering the cohesive areas, when appropriate, and analyzing the cohesive areas based upon analysis criteria;
g) storing at least one of the analyzed area data and segment data in a data memory; and
h) repeating steps a) to g) for the same small animal at time intervals.

2. The image analysis process as claimed in claim 1, further comprising:
i) quantifying at least one of the analyzed area data and segment data;
j) comparing at least one of the quantified area data and segment data with at least one of stored area data and segment data from at least one previous analysis process;
k) at least one of measuring and detecting a change in at least one of the segments and the cohesive areas; and
l) storing results in a databank.

3. The image analysis process as claimed in claim 1, wherein the segmenting of the image data is carried out based upon the watershed algorithm, by at least one of region growing and conversion to binary form.

4. The image analysis process as claimed in claim 1, wherein the image data, before carrying out the step a), is determined by at least one of optical fluorescence, magnetic resonance, computer tomography and nuclear medical processes.

5. The image analysis process as claimed in claim 1, wherein run length encoding is used as the association criterion for the associating of the segments in order to form cohesive areas, and wherein the cohesive areas are then post-processed.

6. The image analysis process as claimed in claim 1, wherein at least one of a centroid, a size, a mass and at least one substance concentration, at least one of obtained from the encoding of the image data and calculated from the image data, is used as the analysis criterion for analysis of the cohesive areas.

7. The image analysis process as claimed in claim 1, wherein the measured changes in at least one of the segments and in the cohesive areas are stored as a dynamic sequence observation of at least one of a tumor and some other debilitation.

8. The image analysis process as claimed in claim 1, wherein the process steps a) to h) are carried out and displayed automatically on the basis of a predetermined workflow.

9. An in vivo small animal imaging apparatus, comprising:
means for preparation of a small animal;
an imaging examination device for recording of at least one of two-dimensional and three-dimensional images of the small animal;
means for reading the at least one of the two-dimensional and three-dimensional image data for the small animal;
means for segmenting the image data, based upon image data characteristics, into segments, wherein the image data characteristics represent areas of interest for the small animal;
means for forming cohesive areas by associating the segments on the basis of association criteria, wherein the cohesive areas are filtered by masking out the remaining image data which is not associated with the cohesive areas;
means for filtering the cohesive areas, if appropriate, and for analyzing the cohesive areas based upon analysis criteria;
means for storing at least one of the analyzed area data and segment data.

10. The apparatus as claimed in claim 9, wherein results are stored in an experimental databank, permitting long-term comparison of the measured analysis data.

11. The apparatus as claimed in claim 9, further comprising:
means for graphical comparison and indication of the measured changes in at least one of the segments and in the cohesive areas, in the dynamic sequence observation, in the analysis criteria and their results, and in the data from an experimental databank, and means for displaying on the basis of workflows.

12. The image analysis process as claimed in claim 1, wherein the image data characteristics are predetermined.

13. The image analysis process as claimed in claim 1, wherein the association criteria are predetermined.

14. The image analysis process as claimed in claim 12, wherein the association criteria are predetermined.

15. The image analysis process as claimed in claim 14, wherein the analysis criteria are predetermined.

16. The image analysis process as claimed in claim 1, wherein the analysis criteria are predetermined.

17. The image analysis process as claimed in claim 2, wherein the segmenting of the image data is carried out based upon the watershed algorithm, by at least one of region growing and conversion to binary form.

18. The image analysis process as claimed in claim 1, wherein the measured changes are displayed.

19. The apparatus as claimed in claim 10, further comprising:
means for graphical comparison and indication of the measured changes in at least one of the segments and in the cohesive areas, in the dynamic sequence observation, in the analysis criteria and their results, and in the data from the experimental databank, and means for displaying on the basis of workflows.

20. The apparatus as claimed in claim 9, wherein the image data characteristics are predetermined.

21. The apparatus as claimed in claim 9, wherein the association criteria are predetermined.

22. The apparatus as claimed in claim 20, wherein the association criteria are predetermined.

23. The apparatus as claimed in claim 22, wherein the analysis criteria are predetermined.

24. The apparatus as claimed in claim 9, wherein the analysis criteria are predetermined.

25. A process, comprising:
recording a multi-dimensional image of a subject;
segmenting image data of the image into segments, based upon image data characteristics, wherein the image data characteristics represent areas of interest of the subject;
forming cohesive areas by associating the segments based upon association criteria, and by masking out remaining image data not associated with the cohesive areas;
filtering the cohesive areas, when appropriate, and analyzing the cohesive areas based upon analysis criteria; and
storing at least one of the analyzed area data and segment data in a data memory.

26. The process as claimed in claim 25, further comprising:
repeating at least one of the steps at time intervals.

27. The process of claim 25, wherein the subject is an animal.

28. The process as claimed in claim 25, further comprising:
quantifying at least one of the analyzed area data and segment data;
comparing at least one of the quantified area data and segment data with at least one of stored area data and segment data from at least one previous analysis process;
at least one of measuring and detecting a change in at least one of the segments and the cohesive areas; and
storing results in a databank.

29. The process as claimed in claim 25, wherein the segmenting of the image data is carried out based upon the watershed algorithm, by at least one of region growing and conversion to binary form.

30. The process as claimed in claim 25, wherein the image data, before carrying out the step of recording, is determined by at least one of optical fluorescence, magnetic resonance, computer tomography and a nuclear medical process performed on the subject.

31. The process as claimed in claim 25, wherein run length encoding is used as the association criterion for the associating of the segments in order to form cohesive areas, and wherein the cohesive areas are then post-processed.

32. The process as claimed in claim 27, wherein the image data characteristics represent areas of interest for the animal.

33. An apparatus, comprising:
means for recording a multi-dimensional image of a subject;
means for segmenting image data of the image into segments, based upon image data characteristics, wherein the image data characteristics represent areas of interest of the subject;
means for forming cohesive areas by associating the segments based upon association criteria, and by masking out remaining image data not associated with the cohesive areas;
means for filtering the cohesive areas, when appropriate, and analyzing the cohesive areas based upon analysis criteria; and
means for storing at least one of the analyzed area data and segment data in a data memory.

34. The apparatus of claim 33, wherein the subject is an animal.

35. The apparatus as claimed in claim 33, further comprising:
means for quantifying at least one of the analyzed area data and segment data;
means for comparing at least one of the quantified area data and segment data with at least one of stored area data and segment data from at least one previous analysis process;
means for at least one of measuring and detecting a change in at least one of the segments and the cohesive areas; and
means for storing results in a databank.

36. The apparatus as claimed in claim 33, wherein the segmenting of the image data is carried out based upon the watershed algorithm, by at least one of region growing and conversion to binary form.

37. The apparatus as claimed in claim 33, wherein the image data, before carrying out the step of recording, is determined by at least one of optical fluorescence, magnetic resonance, computer tomography and a nuclear medical process performed on the subject.

38. The apparatus as claimed in claim 34, wherein the image data characteristics represent areas of interest for the animal.
